(19) United States
(12) Patent Application Publication
(10) Pub. No.: US 2012/0176517 A1
(43) Pub. Date: Jul. 12, 2012

(54) DIGITAL IMAGE PHOTOGRAPHING APPARATUS AND METHODS OF CONTROLLING THE SAME

(75) Inventor: Yun-mi Lee, Suwon-si (KR)

(73) Assignee: Samsung Electronics Co., Ltd., Suwon-si (KR)

(21) Appl. No.: 13/272,320

(22) Filed: Oct. 13, 2011

(30) Foreign Application Priority Data
Jan. 7, 2011 (KR) 10-2011-0001792

(51) Int. Cl. H04N 5/262; H04N 5/228

(52) U.S. Cl. 348/240.99; 348/222.1; 348/E05.055; 348/E05.031

(57) ABSTRACT

A digital image photographing apparatus for informing a user (e.g., a photographer) that a size difference between detected face areas is greater than a predetermined reference difference by comparing sizes of the detected face areas with each other and methods of controlling the same are disclosed. Thus, when a plurality of people is photographed, a captured image in which sizes of detected face areas are similar to each other may be acquired.

### CROSS-REFERENCE TO RELATED PATENT APPLICATION

This application claims the priority benefit of Korean Patent Application No. 10-2011-0001792, filed on Jan. 7, 2011 in the Korean Intellectual Property Office, which is hereby incorporated by reference in its entirety.

### BACKGROUND

1. Field of the Invention

The invention generally relates to a digital image photographing apparatus and methods of controlling the same.

2. Description of the Related Art

When a plurality of people is photographed, an image captured may be undesirable when faces therein are different sizes. In particular, if a photographer cannot see a live view image (e.g., when a camera is to perform remote control capturing, self capturing, or self time capturing), an image may be captured in which people further from the camera appear to have relatively smaller faces than people closer to the camera. Accordingly, image capturing may have to be repeated until a desired image is captured.

### SUMMARY

Example digital image photographing apparatus for capturing an image in which sizes of detected face areas are similar to each other, and methods of controlling the same are disclosed.

According to an embodiment, there is provided a method of controlling a digital image photographing apparatus, the method including: obtaining an input image by photographing a plurality of subjects; detecting a plurality of face areas in the input image; determining whether the subjects are disposed in a straight line; and when the subjects are disposed in a straight line, comparing a size difference between the plurality of face areas to a reference difference to determine whether to output a control signal.

According to another embodiment, there is provided a digital image photographing apparatus including: an input image generator to generate an input image by photographing a plurality of subjects; a face area detector to detect a plurality of face areas in the input image; a face area comparator to compare the plurality of face areas with each other; and a first control signal generator to, when a size difference between the plurality of face areas is greater than a reference difference, generate and output a control signal.

According to other embodiments, a digital image photographing apparatus informs a user (photographer) that a size difference between detected face areas is greater than a predetermined reference difference by comparing sizes of the detected face areas with each other and methods of controlling the same may be provided. Thus, when a plurality of people is photographed, a captured image in which sizes of detected face areas are similar to each other may be acquired.

### BRIEF DESCRIPTION OF THE DRAWINGS

The above and other features and advantages will become more apparent by describing in detail exemplary embodiments thereof with reference to the attached drawings in which:

FIG. 1 is a block diagram of a digital camera as an example of a digital image photographing apparatus, according to an embodiment;

FIG. 2 is a block diagram of an Image Signal Processor/Central Processing Unit (ISP/CPU) of the digital camera of FIG. 1, according to an embodiment;

FIGS. 3 and 4 are screens operating according to the ISP/CPU of FIG. 2;

FIG. 5 is a block diagram of the ISP/CPU of the digital camera of FIG. 1, according to another embodiment;

FIGS. 6 to 10 are diagrams for describing operations of the ISP/CPU of FIG. 5;

FIG. 11 is a flowchart illustrating a method of controlling the digital image photographing apparatus, according to an embodiment; and

FIG. 12 is a flowchart illustrating a method of controlling the digital image photographing apparatus, according to another embodiment.

### DETAILED DESCRIPTION

A digital image photographing apparatus according to the invention will now be described more fully with reference to the accompanying drawings, in which exemplary embodiments of the invention are shown. In the embodiments below, a digital camera is illustrated as the digital image photographing apparatus. However, the invention is not limited thereto and is applicable to digital devices, such as a digital camcorder, a Personal Digital Assistant (PDA), and a smart phone.

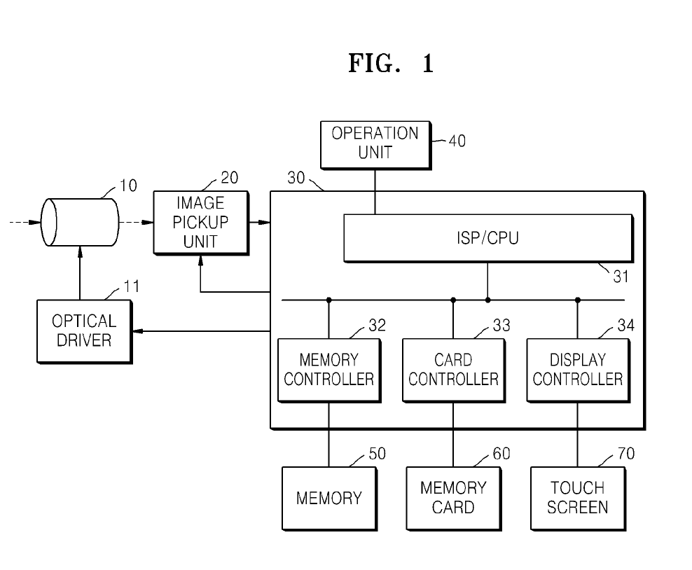

FIG. 1 is a block diagram of a digital camera as an example of a digital image photographing apparatus, according to an embodiment.

Referring to FIG. 1, the digital camera may include an optical unit 10, an optical driver 11 for driving the optical unit 10, an image pickup unit 20, a camera controller 30, an operation unit 40, a memory 50, a memory card 60, and a display device such as a touch screen 70.

The optical unit 10 may include an image focus optical system for focusing an optical signal from a subject, a shutter, and an iris. The image focus optical system may be a replaceable lens including a focus lens for adjusting a focus and/or a zoom lens for adjusting a focal distance.

The optical driver 11 may include a focus lens driver for adjusting a position of the focus lens, an iris driver for adjusting opening/closing of the iris, and a shutter driver for adjusting opening/closing of the shutter.

The image pickup unit 20 may include an image pickup device for generating an image signal by picking up image light passing through the image focus optical system. The image pickup device may include a plurality of photoelectric converters arranged in a matrix pattern and a vertical and/or horizontal transmission path for moving electric charges from the photoelectric converters in synchronization with a timing signal to derive an image signal. A Charge Coupled Device (CCD) sensor or a Complementary Metal Oxide Semiconductor (CMOS) sensor may be used as the image pickup device. When a CCD sensor is used, the image pickup unit 20 may further include a Correlated Double Sampling/Amplifier (CDS/AMP) for removing low-frequency noise included in an electrical signal output from the image pickup device and simultaneously amplifying the electrical signal to a predetermined level, and an Analog-to-Digital (A/D) converter for converting the electrical signal output from the CDS/AMP into a digital signal.

The digital camera may include the camera controller 30. The camera controller 30 may include an Image Signal Processor/Central Processing Unit (ISP/CPU) 31.

The ISP/CPU 31 may generate an Auto White Balance (AWB) evaluation value for white balance adjustment of an image signal acquired by the image pickup unit 20, an Auto Exposure (AE) evaluation value for exposure adjustment of the image signal, and an Auto Focusing (AF) evaluation value for focus adjustment of the image signal, and control proper white balance adjustment, proper exposure adjustment, and proper focus adjustment according to the calculated evaluation values. In addition, the ISP/CPU 31 may perform various application operations, such as object recognition like face recognition and scene recognition, with respect to an input image signal. In addition, the ISP/CPU 31 may perform image processing for record preservation and image processing for displaying. Examples of the image processing are gamma collection, color filter array interpolation, color matrix, color correction, and color enhancement. In addition, the ISP/CPU 31 may perform compression according to a compression format, such as a Joint Photographic Experts Group (JPEG) compression format or a Lempel-Ziv Welch (LZW) compression format for image storage or record preservation.

The camera controller 30 may further include a memory controller 32, a card controller 33, and a display controller 34.

The memory controller 32 may temporarily store captured images and various kinds of information in the memory 50 or output captured images and various kinds of information from the memory 50. In addition, the memory controller 32 may read program information stored in the memory 50. The memory 50 is a buffer memory for temporarily storing captured images and various kinds of information and may include a Dynamic Random Access Memory (DRAM) or a Synchronous Dynamic Random Access Memory (SDRAM). In addition, the memory 50 may further include a flash memory or a Read Only Memory (ROM) as a storage unit for storing programs.

The card controller 33 may store or read an image file in or from the memory card 60. The card controller 33 may also control the memory card 60 to store or read various kinds of information. The memory card 60 may be, for example, a Secure Digital (SD) card. Although the memory card 60 is used as a storage medium in the current embodiment, the invention is not limited thereto, and an image file and various kinds of information may be stored on any number and/or type(s) of recording media such as an optical disc (a Compact Disc (CD), a Digital Versatile Disc (DVD), or a Blu-ray Disc (BD)), an magneto-optical disc, or a magnetic disc. When a recording medium, such as an optical disc (a CD, a DVD, or a BD), a magneto-optical disc, or a magnetic disc, is used, a reading device for reading the recording medium may be further included.

The display controller 34 may control image or control display or presentation on the example touch screen 70. The touch screen 70 may include a touch panel on a display device, such as a Liquid Crystal Display (LCD) or an Organic Light Emitting Diode (OLED) display.

The digital camera may include the operation unit 40 for inputting a user's operation signal. The operation unit 40 may include a member that may be manipulated by the user in order to operate the digital camera or set various values used in image capturing. For example, the member may be implemented as a button, a key, a touch panel, a touch screen, or a dial and may input a user operation signal, such as power on/off, capturing start/stop, reproduction start/stop/search, driving of an optical system, a mode change (e.g., execution of a video capturing mode), a menu operation, or a selection operation. For example, a shutter button may be half-pressed, full-pressed, or released by the user. The shutter button may output a focus control start operation signal when the shutter button is half-pressed (S1 operation) and end a focus control when the half-press is released. The shutter button may output a capturing start operation signal when the shutter button is full-pressed (S2 operation). The operation signals may be transmitted to the ISP/CPU 31 to drive corresponding components.

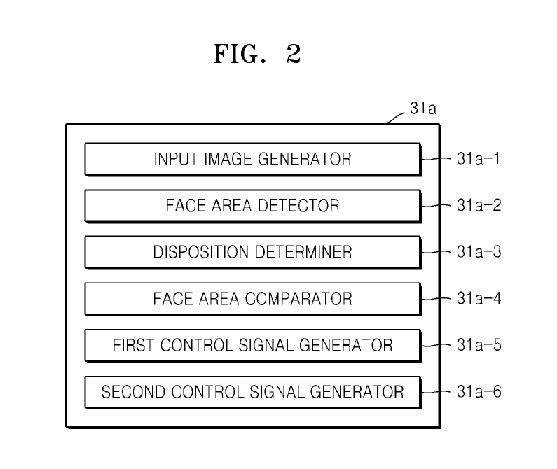

FIG. 2 is a block diagram of the ISP/CPU 31 (31a) of the digital camera of FIG. 1, according to an embodiment.

Referring to FIG. 2, the ISP/CPU 31a according to the current embodiment may include an input image generator 31a-1, a face area detector 31a-2, a disposition determiner 31a-3, a face area comparator 31a-4, and a first control signal generator 31a-5.

The input image generator 31a-1 generates, captures or otherwise obtains an input image by photographing a plurality of subjects. In detail, when an image pickup surface of the image pickup unit 20 is exposed to light, the input image generator 31a-1 may generate the input image by image processing data accumulated by the image pickup unit 20 for post-processing.

The face area detector 31a-2 detects a plurality of face areas by using a face recognition algorithm on the input image.

The disposition determiner 31a-3 determines whether the subjects are substantially disposed in a straight line. For example, the disposition determiner 31a-3 may determine whether the detected face areas are substantially disposed in a straight line along a horizontal direction (e.g., left-to-right and/or right-to-left across the input image). In more detail, when the plurality of face areas are disposed in the horizontal direction within a predetermined criterion (e.g., N degrees), it may be determined that the plurality of face areas are substantially disposed in a straight line.

The face area comparator 31a-4 may compare sizes of the plurality of face areas with each other when the subjects are substantially disposed in a straight line along, for example, the horizontal direction. That is, the face area comparator 31a-4 may determine whether a size difference between the plurality of face areas is greater than a threshold such as a reference difference.

The first control signal generator 31a-5 may output a control signal when the size difference between the plurality of face areas is greater than the reference difference. Example control signals include, but are not limited to, an audio signal, an optical signal, or an image signal to alert a user. The audio signal may include an alert sound, or an alert message sound. The optical signal may be generated by, for example, emitting light from an alert lamp such as an LED lamp. The image signal may include an alert display image or an alert message image.

The ISP/CPU 31a may further include a second control signal generator 31a-6 for generating a capturing signal when the size difference between the plurality of face areas is less than the reference difference. For example, the second control signal generator 31a-6 may generate and output a capturing signal to automatically perform capturing when the size difference between the plurality of face areas is less than the reference difference, i.e., when the sizes of the plurality of face areas are substantially similar to each other. When the image pickup surface of the image pickup device 20 is exposed by driving the shutter and the iris according to the capturing signal, a captured image may be generated.

FIG. 3 is an example screen showing a plurality of people that are to be photographed, wherein sizes of face areas of the people are different. In detail, referring to FIG. 3, face areas F1 to F7 of 7 people to be photographed are detected, and sizes of the face areas F4 and F5 are smaller than sizes of the face areas F1 to F3 and F6 to F7. In this case, an image in which facial sizes are similar may be captured by outputting a user alert sound, an alert voice, and/or an LED as a guide to alert a user to reposition the people to make the facial sizes more similar.

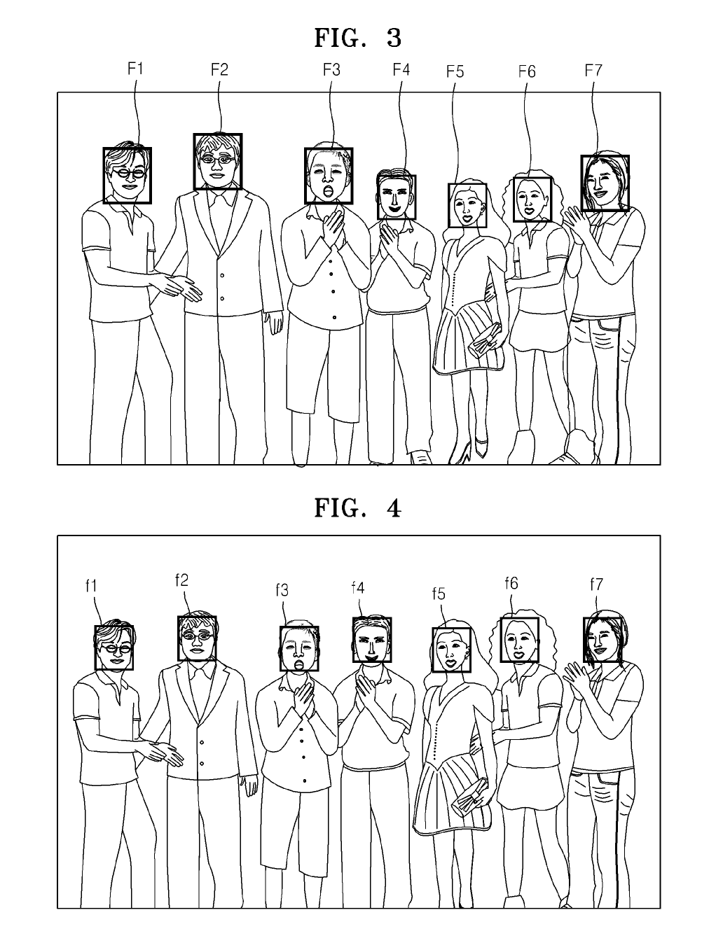

FIG. 4 shows another example screen where sizes of face areas of people are made similar by adjusting poses and positions of the people according to a user alert signal. Referring to FIG. 4, when a size difference between a plurality of face areas f1 to f7 is less than the reference difference, i.e., when facial sizes of the plurality of face areas f1 to f7 are similar to each other, a user alert signal indicating that the facial sizes are substantially similar may be output. For example, an alarm or voice (e.g., Good!) may be output. Furthermore, a capturing signal for automatic capturing of an image may be generated.

Referring to the configuration of FIG. 2, the first control signal generator 31a-5 may generate a corresponding control signal, such as a user alert signal, if a difference between a plurality of face areas is greater than the reference difference, and the second control signal generator 31a-6 may generate a corresponding control signal, such as an automatic capturing control signal, if the difference between the plurality of face areas is less than the reference difference.

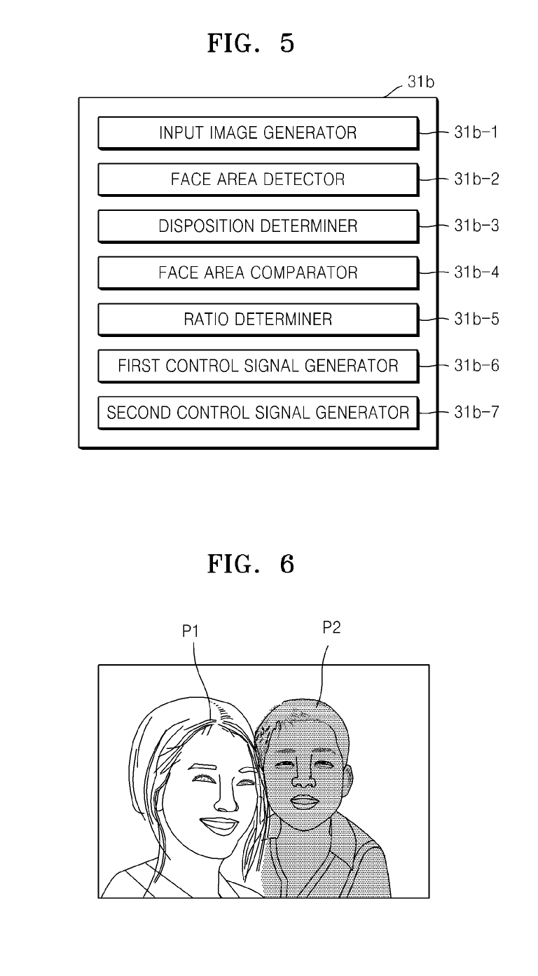

FIG. 5 is a block diagram of the ISP/CPU 31 (31b) of the digital camera of FIG. 1, according to another embodiment. Since the ISP/CPU 31b of FIG. 5 is similar to the ISP/CPU 31a of FIG. 2, a difference there between is mainly described.

Referring to FIG. 5, the ISP/CPU 31b, according to the current embodiment, may include an input image generator 31b-1, a face area detector 31b-2, a disposition determiner 31b-3, and a face area comparator 31b-4.

The input image generator 31b-1 may generate an input image according to an image signal provided by the image pickup device 20, the face area detector 31b-2 may detect a plurality of face areas by using a face recognition algorithm on the input image, and the disposition determiner 31b-3 may determine whether the plurality of detected face areas are disposed in a straight line along, for example, a horizontal direction.

The face area comparator 31b-4 may determine whether a size difference between the plurality of detected face areas is greater than a threshold such as a reference difference. Alternatively, the face area comparator 31b-4 may determine whether the size difference between the plurality of detected face areas is less than the reference difference.

The ISP/CPU 31b may further include a ratio determiner 31b-5 for comparing a face ratio of each of the plurality of detected face areas of the input image with a reference face ratio. A case where a face ratio may be small is when a body and face are photographed together. Depending on the relative positioning of the body and face, facial size may be may be artificially changed resulting in a photograph in which a ratio of the face to the body is abnormal. To automatically adjust a face area when a face ratio corresponds to a specific condition, the example disposition determiner 31b-3 determines, computes and/or derives an area or size ratio of a face area, and compares the area or size reference with a threshold such as a reference face ratio. For example, a face ratio of a face area having a relatively small size among the plurality of detected face areas as a result of the determination of the face area comparator 31b-4 may be compared with the reference face ratio. This is to check whether a small-sized face area may be magnification-processed to make sizes of face areas more similar.

A first control signal generator 31b-6 for generating a magnification signal may be further included to automatically perform, start, initiate or trigger the magnification process on a comparatively small face area when it is determined by the face area comparator 31b-4 that the size difference between the detected face areas is greater than the reference difference and when it is determined by the ratio determiner 31b-5 that the face ratio of each of the plurality of detected face areas to the input image is greater than the reference face ratio.

Although not shown, the ISP/CPU 31b may further include a face area determiner for determining a face area to be magnified according to the magnification signal and a synthesizer for selectively magnifying the determined face area and synthesizing the magnified face area in a corresponding position of the input image. The face area determiner may determine a face area by detecting, for example, at least one edge of hair and skin based on face areas detected using a face recognition algorithm and will be described in detail with reference the accompanying drawings later. Here, the face area to be magnified may be a face area having a comparatively small size among the detected face areas.

If the size difference between the face areas detected by the face area comparator 31b-4 is greater than the reference difference and if it is determined by the ratio determiner 31b-5 that the face ratio of each of the plurality of detected face areas to the input image is less than the reference face ratio, the first control signal generator 31b-6 may generate a user alert signal.

If the size difference between the face areas detected by the face area comparator 31b-4 is less than the reference difference, regardless of whether it is determined by the ratio determiner 31b-5 that the face ratio of each of the plurality of detected face areas to the input image is greater or less than the reference face ratio, the first control signal generator 31b-6 may also generate the user alert signal. This will be described in more detail with reference to FIGS. 6 to 10.

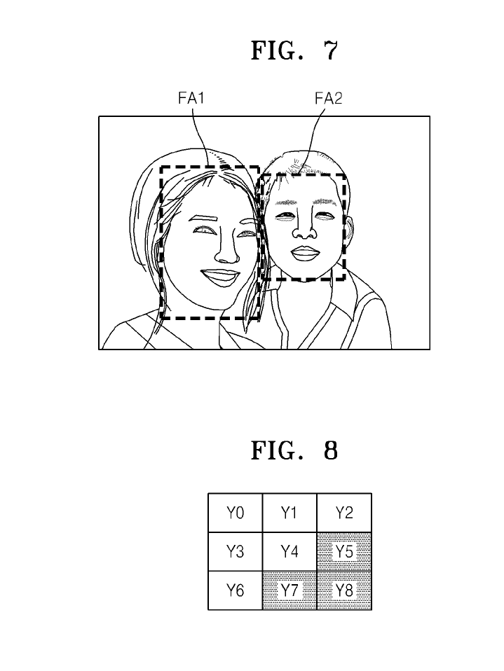

Referring to FIG. 6, an example screen depicting two people P1 and P2 to be photographed in a self-shot is shown. This may correspond to an input image. Referring to FIG. 7, a first face area FA1 and a second face area FA2 may be derived from the input image through a face recognition algorithm. Here, a face area may include a unique face area identified by a skin color and at least a portion of hair. A size of the first face area FA1 and a size of the second face area FA2 are compared with each other, and if a size difference is greater than a threshold such as a predetermined reference difference, it is determined whether a face ratio of the second face area FA2, that is, a relatively small face area, is greater than the reference face ratio. If the face ratio is greater than the reference face ratio, the second face area FA2 may be magnified.

In some embodiments, the second face area FA2 may be automatically magnified. FIG. 8 is a diagram for describing a method of more correctly determining a border of a face area schematically detected using a face recognition algorithm. Referring to FIG. 8, a face edge is first recognized using facial skin color data. When a schematic area extracted from the skin color data is scanned in a horizontal direction, a first absolute value of Y(n)-Y(n−1) is obtained, and if the first absolute value is greater than a first reference value, Yn may be determined as an edge pixel. When the schematic area extracted from the skin color data is scanned in a vertical direction, a second absolute value of Y(n)-Y(n−size in the horizontal direction) is obtained, and if the second absolute value is greater than a second reference value, Yn may be determined as an edge pixel. By synthesizing the two determinations according to the scanning directions, a final edge pixel position may be obtained.

A face area may be determined by further recognizing an edge of a head portion using hair color data. A schematic face area may be detected using a face recognition algorithm, and a hair area may be extracted using hair color data from the face area. A portion of the face area other than a portion recognized as a face, extracted using skin color data, may be extracted as the hair area. When the face area and the hair area overlap each other, the two areas may be determined as the face area by synthesizing the two areas into one area. Alternatively, the hair area may be extracted by scanning areas above, below, to the left of, and to the right of a center of the face area. Like the method of FIG. 8, a method of recognizing an edge of a hair portion may determine whether a corresponding pixel is the edge of the hair portion by generally determining a result of scans in the horizontal and vertical directions.

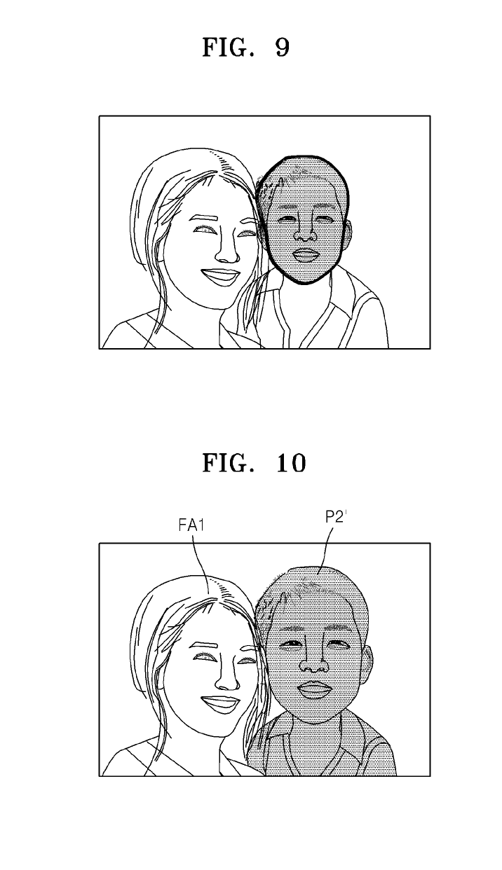

FIG. 9 is a drawing in which an edge of an extracted face area is set. Referring to FIG. 9, an area in which a magnified image of the face area is to be synthesized without damaging an existing image may be set, and the magnified image may be synthesized without overlapping the remaining portion of the existing image based on an edge of the existing image. Thus, a natural image in which sizes of face areas are similar may be acquired.

FIG. 10 is a final image synthesized by magnifying a face area having a small size as described above. According to the current embodiment, a natural image having similar facial sizes may be acquired.

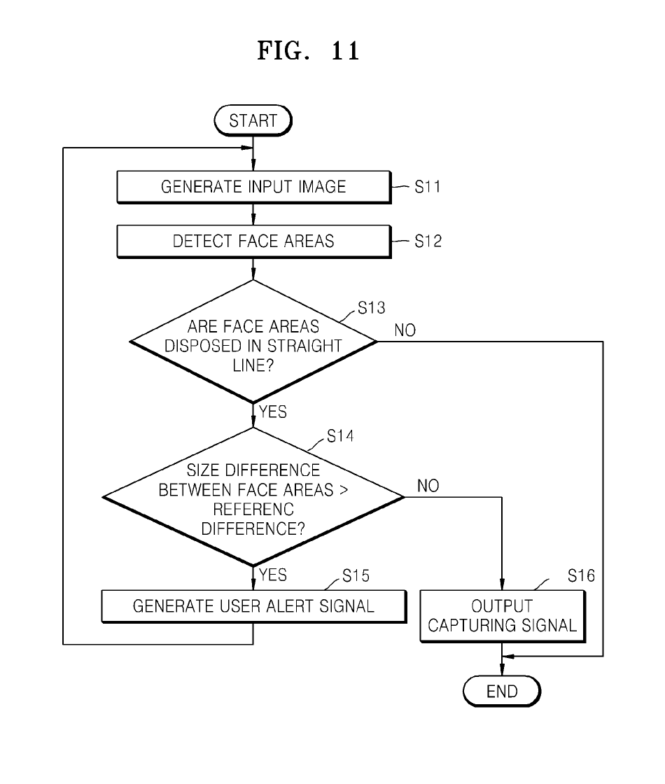

FIG. 11 is a flowchart of a method of controlling the digital image photographing apparatus, according to an exemplary embodiment.

Referring to FIG. 11, in operation S11, an input image is generated.

In operation S12, a plurality of face areas are detected in the input image by using a face recognition algorithm.

In operation S13, it is determined whether the detected face areas are substantially disposed in a straight line. If the detected face areas are substantially disposed in a straight line, it is determined in operation S14 whether a size difference between the face areas is greater than the reference difference.

If the size difference between the face areas is greater than the reference difference, a user alert signal is generated in operation S15. Otherwise, a captured image is automatically generated by generating a capturing signal in operation S16.

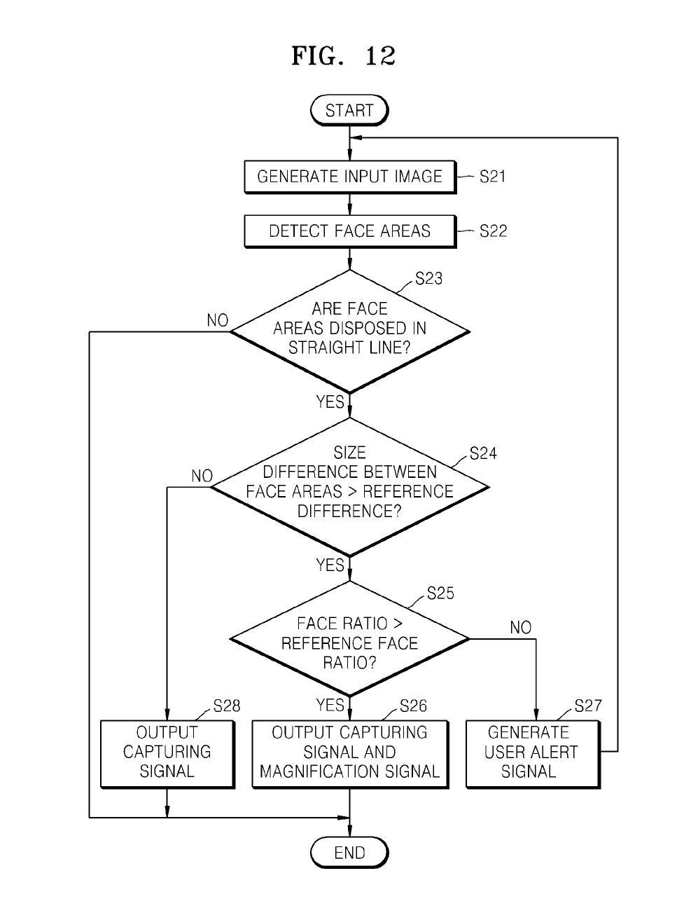

FIG. 12 is a flowchart of a method of controlling a digital image photographing apparatus such as the example digital camera of FIG. 1, according to another embodiment. Referring to FIG. 12, in operation S21, an input image is generated.

In operation S22, a plurality of face areas are detected from the input image.

In operation S23, it is determined whether the plurality of detected face areas is substantially disposed in a straight line along, for example, the horizontal direction.

In operation S24, it is determined whether a difference between the detected face areas is greater than the reference difference.

If the difference between the detected face areas is greater than the reference difference, it is determined in operation S25 whether a face ratio of each of the detected face areas to the input image is greater than the reference face ratio. If the face ratio is greater than the reference face ratio, a magnification signal is output in operation S26. At least one of the detected face areas is magnified according to the magnification signal, and the magnified face area is synthesized in a position of the at least one detected face area in the input image. Since an operation of determining a face area to be magnified and an operation of magnifying and synthesizing the determined face area have been described with reference to FIGS. 6 to 10, the description of the operations is omitted here.

If the face ratio is less than the reference face ratio, a user alert signal is generated in operation S27. A user such as a photographer may reposition subjects to make facial sizes similar by changing positions and dispositions according to the user alert signal. Thereafter, the process waits for capturing to continue, generates an input image in operation S21, and repeats the remaining operations.

If it is determined in operation S24 that the difference between the detected face areas is not greater than the reference difference, a capturing signal is output in operation S28, and the process ends.

If it is determined in operation S23 that the plurality of detected face areas is not disposed in a straight line, the process ends.

The methods disclosed herein may be implemented through machine-readable instructions recorded on a tangible article of manufacture such as a computer-readable storage media and executed by one or more processors. The machine-readable instructions may include individual or any combination of program instructions, data files, and/or data structures. The program instructions recorded on the computer-readable storage media can be specially designed and/or constructed as known to and/or used by a person skilled in the art of computer software. Examples of the computer readable storage media include magnetic media (e.g., hard disks, floppy disks, magnetic tapes, etc), optical recording media (e.g., CD-ROMs, or DVDs), magneto-optical media such as floppy disks, and/or hardware devices specially configured to store and perform program instructions (ROM, RAM, flash memories, etc). Computer-readable storage media may be distributed over network coupled computer systems so that the machine-readable instructions are stored and/or executed in a distributed fashion. This media can be read by the computer, stored in its memory, and executed by a processor. Examples of program instructions include machine language codes produced by a compiler and/or high-level language codes that can be executed by a computer using an interpreter. The hardware devices can be constructed as one or more software modules in order to perform the operations according to the present disclosure, and vice versa.

Also, using the disclosure herein, programmers of ordinary skill in the art to which the invention pertains can easily implement functional programs, codes, and code segments for making and using the invention.

The embodiments disclosed herein may be described in terms of functional block components and/or methods. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of this disclosure are implemented using software programming and/or software elements, the disclosed embodiments may be implemented with any programming or scripting language such as C, C++, Java, assembler, or the like, with the various algorithms being implemented with any combination of data structures, objects, processes, routines and/or other programming elements. Functional aspects may be implemented in algorithms that execute on one or more processors. Furthermore, the disclosed embodiments may employ any number of conventional techniques for electronics configuration, signal processing and/or control, data processing and the like. Finally, the steps of the methods described herein can be performed in any suitable order unless otherwise indicated herein and/or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the disclosed embodiments, reference has been made to the embodiments illustrated in the drawings, and specific language has been used to describe these embodiments. However, no limitation of the scope of the claimed inventions is intended by this specific language, and the claimed inventions should be construed to encompass all embodiments that would normally occur to one of ordinary skill in the art. The terminology used herein is for the purpose of describing the particular embodiments and is not intended to be limiting of embodiments of the claimed inventions.

The use of any and all examples, or exemplary language (e.g., “such as”) provided herein, is intended merely to better illuminate the claimed inventions and does not pose a limitation on the scope of the claimed inventions unless otherwise claimed. Numerous modifications and adaptations will be readily apparent to those of ordinary skill in this art without departing from the spirit and scope of the claimed inventions. Therefore, the scope of the claimed inventions is defined not by the detailed description but includes all equivalents and differences within the scope of the present disclosure.

No item or component is essential to the practice of the disclosed embodiments unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the disclosed embodiments (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

While digital photographing apparatus and methods have been particularly shown and described with reference to exemplary embodiments thereof, it will be understood by those of ordinary skill in the art that various changes in form and details may be made therein without departing from the spirit and scope of the disclosure and/or as defined by the following claims or their equivalents.

What is claimed is:

1. A method of controlling a digital image photographing apparatus, the method comprising:
obtaining an input image by photographing a plurality of subjects;
detecting a plurality of face areas in the input image;
determining whether the subjects are substantially disposed in a straight line;
when the subjects are substantially disposed in a straight line, comparing a size difference between the plurality of face areas to a reference difference to determine whether to output a control signal.

2. The method of claim 1, wherein determining whether the subjects are substantially disposed in a straight line comprises determining whether the detected face areas are substantially disposed in a straight line along a horizontal direction within a predetermined range.

3. The method of claim 1, wherein the outputting of the control signal comprises outputting at least one of an audio signal, an optical signal, and an image signal to alert a user.

4. The method of claim 1, further comprising, when the difference is less than the reference difference, outputting a capturing signal.

5. The method of claim 1, further comprising comparing a face ratio of each detected face area with a reference face ratio,
wherein the outputting of the control signal comprises outputting a control signal comprising at least one of an audio signal, an optical signal, and an image signal to alert a user when the face ratio is less than the reference face ratio and when the difference between the plurality of face areas is more than the reference difference.

6. The method of claim 1, further comprising comparing a face ratio of each detected face area with a reference face ratio,
wherein the outputting of the control signal comprises outputting a magnification signal for magnifying a relatively small face area to fit a relatively large face area when the face ratio is greater than the reference face ratio and when the difference between the plurality of face areas is more than the reference difference.

7. The method of claim 6, further comprising:
determining a face area to be magnified according to the magnification signal; and
selectively magnifying the determined face area; and
synthesizing the magnified face area in a corresponding position of the input image.

8. The method of claim 7, wherein the determining comprises determining the face area to be magnified by detecting an edge of at least one of hair and skin based on a face area detected by using a face recognition algorithm.

9. The method of claim 7, wherein the face area to be magnified is a face area having a smaller size compared to the detected face areas.

10. The method of claim 1, further comprising comparing a face ratio of each detected face area with a reference face ratio,
wherein the outputting of the control signal comprises outputting a capturing signal for generating a capturing image when the face ratio is more than the reference face ratio and when the difference between the plurality of face areas is less than the reference difference.

11. A digital image photographing apparatus comprising:
an input image generator to generate an input image by photographing a plurality of subjects;
a face area detector to detect a plurality of face areas in the input image;
a face area comparator to compare the plurality of face areas with each other; and
a first control signal generator to, when a size difference between the plurality of face areas is greater than a reference difference, generate and output a control signal.

12. The digital image photographing apparatus of claim 11, further comprising a disposition determiner to determine whether the detected face areas are substantially disposed in a straight line, wherein the face area comparator is to compare the plurality of face areas when the detected face areas are substantially disposed in the straight line.

13. The digital image photographing apparatus of claim 11, wherein the first control signal generator is to generate and output a control signal comprising at least one of an audio signal, an optical signal, and an image signal to alert a user when the difference between the plurality of face areas is more than the reference difference.

14. The digital image photographing apparatus of claim 11, further comprising a second control signal generator to output a capturing signal when the size difference between the plurality of face areas is less than the reference difference.

15. The digital image photographing apparatus of claim 11, further comprising a face area comparator to compare a face ratio of each detected face area to a reference face ratio,
wherein the first control signal generator is to output a control signal comprising at least one of an audio signal, an optical signal, and an image signal to alert a user when the face ratio is less than the reference face ratio and when the difference between the plurality of face areas is more than the reference difference.

16. The digital image photographing apparatus of claim 11, further comprising a face area comparator to compare a face ratio of each detected face area with a reference face ratio,
wherein the first control signal generator outputs a magnification signal for magnifying a relatively small face area to fit a relatively large face area when the face ratio is greater than the reference face ratio and when the difference between the plurality of face areas is more than the reference difference.

17. The digital image photographing apparatus of claim 16, further comprising:
a face area determiner to determine a face area to be magnified according to the magnification signal; and
a synthesizer to selectively magnifying the determined face area and synthesizing the magnified face area in a corresponding position in the input image.

18. The digital image photographing apparatus of claim 17, wherein the face area determiner is to determine the face area to be magnified by detecting an edge of at least one of hair or skin based on a face area detected by using a face recognition algorithm.

19. The digital image photographing apparatus of claim 17, wherein the face area to be magnified is a face area having a relatively small size among the detected face areas.

20. The digital image photographing apparatus of claim 11, further comprising:
a face area comparator to compare a face ratio of each detected face area with a reference face ratio; and
a second control signal generator to output a capturing signal when the face ratio is more than the reference face ratio and when the size difference is less than the reference difference.
